(19) United States
(12) Patent Application Publication
(10) Pub. No.: US 2009/0310635 A1
(43) Pub. Date: Dec. 17, 2009

(54) WAVELENGTH LOCKER AND LASER PACKAGE INCLUDING SAME

(75) Inventor: Chan Chih Chen, Macungie, PA (US)

Correspondence Address: APPLIED OPTOELECTRONICS, INC., 13115 JESS PIRTLE BLVD., SUGAR LAND, TX, 77478, US

(73) Assignee: APPLIED OPTOELECTRONICS, INC., Sugar Land, TX (US)

(21) Appl. No.: 12/137,749

(22) Filed: Jun. 12, 2008

(51) Int. Cl. H01S 3/13; G01B 9/02

(52) U.S. Cl. 372/32; 356/450

(57) ABSTRACT

A wavelength locker may include a first optical detector configured to detect light, wherein the first optical detector is at least partially transparent to the light. The wavelength locker may further include an optical interferometer optically coupled to the first optical detector and to a second optical detector. The optical interferometer is configured to selectively filter the light that passes through the first optical detector and the second optical detector detects the filtered light. An optical module or package may include the wavelength locker coupled to a laser for locking an emission wavelength of the laser.

### TECHNICAL FIELD

The present invention relates to wavelength lockers and more particularly, relates to a wavelength locker configured for placement in an optical module or package.

### BACKGROUND INFORMATION

The following descriptions and examples are not admitted to be prior art by virtue of their inclusion within this section.

Wavelength Division Multiplex (WDM) systems use lasers as optical sources for transmitting information. Optical channels may be multiplexed using wavelength division multiplexing, thereby allowing approximately simultaneous transmission of multiple channels of data along an optical fiber. Each optical channel may correspond to an optical wavelength.

There are several types of lasers, including gas lasers, solid-state lasers, liquid (dye) lasers, free electron, and semiconductor lasers. Lasers generally have a laser cavity defined by an optical gain medium in the laser cavity and a method for providing optical feedback. The gain medium amplifies electromagnetic waves (light) in the cavity by stimulated emission, thereby providing optical gain. In semiconductor lasers, a semiconductor active region serves as the gain medium. Semiconductor lasers may be diode (bipolar) lasers or non-diode, unipolar lasers such as quantum cascade (QC) lasers. Semiconductor lasers can be built with a variety of structures and semiconductor materials.

In WDM systems, and particularly dense WDM (DWDM) systems, a laser in the optical transmitter generally emits at a desired wavelength. An output of the laser may be sensitive to environment, e.g., temperature, as well as aging. This sensitivity may result in an optical transmitter whose emission wavelength or wavelengths drift. Because of the relatively close channel spacing of WDM and especially DWDM systems, such drift may cause unacceptable interference. To eliminate or minimize drift, the optical source may be “locked” to its desired wavelength. The locking function may be provided, at least in part, by a wavelength locker. An output of the wavelength locker may be used to adjust the emission wavelength of the laser in the optical transmitter.

A wavelength locker is generally optically coupled to the laser within an optical module or package. Multiple beam splitters may be required to optically couple the laser to the wavelength locker (e.g., to a photodiode and to an etalon) and to the optical fiber. In certain types of laser packages, such as a transmitter optical subassembly (TOSA) package, there is limited space for optical components. Thus, incorporating wavelength lockers, and the components required for optically coupling the wavelength lockers, in such packages has presented a unique challenge.

### BRIEF DESCRIPTION OF THE DRAWINGS

These and other features and advantages will be better understood by reading the following detailed description, taken together with the drawings wherein:

FIG. 1 is a schematic diagram of a system including a wavelength locker coupled to a laser, consistent with an embodiment;

FIG. 2 is a schematic diagram of a wavelength locker, consistent with another embodiment;

FIG. 3 is a top view of an embodiment of a TOSA package including a wavelength locker.

### DETAILED DESCRIPTION

Generally, this disclosure describes a wavelength locker that may occupy a relatively reduced physical space to facilitate placement in an optical module or package for locking an emission wavelength of a laser in the module or package. Embodiments of the wavelength locker described herein may be used in optical modules or packages with limited space including, but not limited to, a transmitter optical sub-assembly (TOSA) package, a butterfly package, a dual inline (DIL) package, and a TO (transistor outline) can package. The wavelength locker may include a first optical detector optically coupled to an optical interferometer and a second optical detector optically coupled to the optical interferometer. The first optical detector may be at least partially transparent to incident light such that light from the laser is detected by the first optical detector and passes through into the optical interferometer. A wavelength control circuit may be configured to receive an output from the optical detectors and, based on these outputs, may adjust the emission wavelength of the laser to correspond to a desired wavelength.

As used herein, the term “coupled” may refer to mechanical, optical and/or electrical coupling and does not imply a direct coupling or connection unless otherwise specified. As used herein, the term “optically coupled” refers to at least one coupled element being adapted to impart light to another coupled element directly or indirectly.

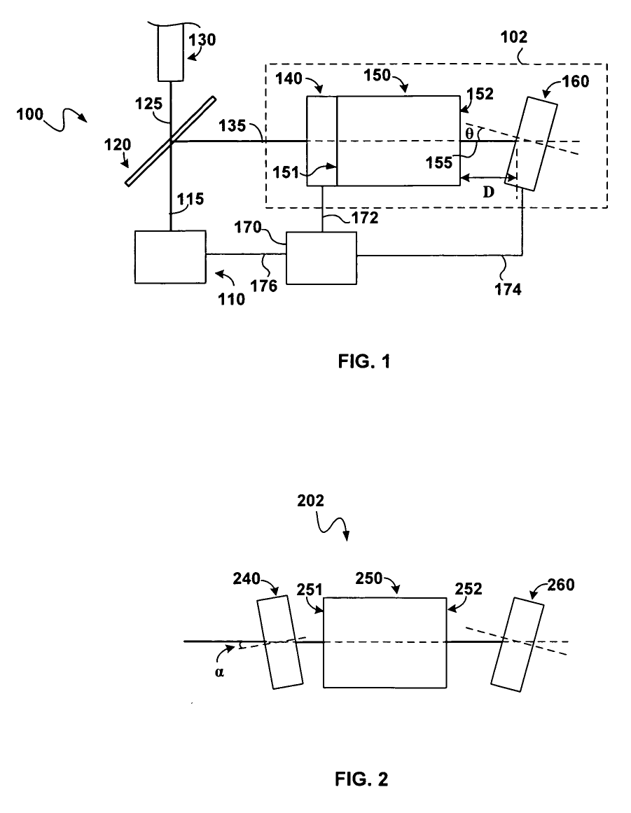

FIG. 1 depicts a schematic representation of a system 100 including an embodiment of a wavelength locker 102 consistent with the present disclosure. At least a portion of the system 100 including the wavelength locker 102 may be implemented in an optical module or package such as a laser package. The wavelength locker 102 may be optically coupled to a laser 110 using a beam splitter 120 and used to stabilize or lock an emission wavelength of the laser 110 to a desired wavelength. The laser 110 may also be optically coupled to an optical fiber 130 via the beam splitter 120 such that laser light at the desired wavelength is transmitted along the optical fiber 130.

The output of the laser 110 may be a beam of laser light 115 at or near the desired wavelength. The beam of laser light 115 may be split by the beam splitter 120 into a first beam 125 directed to the optical fiber 130 and a second beam 135 directed to the wavelength locker 102. The first beam 125 may include a first portion of the total light output of the beam splitter 120 and the second beam 135 may include a second portion of the total light output of the beam splitter 120. For example, the first portion may be about 90% and the second portion may be about 10% of the total light output of the beam splitter 120.

The system 100 may also include other optical components including, but not limited to, a collimator, an isolator and/or a lens (not shown). In other embodiments, the laser 110 may be coupled to the wavelength locker 102 and optical fiber 130 without using the beam splitter 120. For example, a laser may emit light from different sides of the laser (e.g., from a front side and a back side), and the light emitted from the different sides may be directed to the wavelength locker 102 and the optical fiber 130, respectively.

The wavelength locker 102 may include a first optical detector 140, an optical interferometer 150, and a second optical detector 160. The first optical detector 140 may be optically coupled to a first end 151 of the optical interferometer 150 and the second optical detector 160 may be optically coupled to a second end 152 of the optical interferometer 150. The first optical detector 140 may be at least partially optically transparent to an incident beam of light, i.e., at least a portion of the incident beam of light may propagate through the first optical detector 140 without being absorbed.

In general, the first optical detector 140 detects the second beam 135 from the beam splitter 120 and passes at least a portion of the second beam 135 to the optical interferometer 150. The optical interferometer 150 filters the light 145 received from the first optical detector 140, and the second optical detector 150 detects the filtered optical beam 155. In particular, an output of the optical interferometer 150 may be a filtered optical beam 155 wherein incident light is amplified and/or attenuated as a function of wavelength. Using a first optical detector 140 that is at least partially transparent eliminates the need for certain components, such as an additional beam splitter to split the beam 135 between the first optical detector 140 and the optical interferometer 150.

In one embodiment, the optical interferometer 150 is a Fabry-Perot interferometer or etalon such as the type known for use in wavelength lockers. The optical interferometer 150 acts as a wavelength reference calibrated to the desired wavelength, and the detected output of the optical interferometer 150 from the second optical detector 160 indicates a difference between a desired emission wavelength and an actual emission wavelength of the laser 110. The first optical detector 140 provides a power reference used to normalize the detected output of the optical interferometer 150 such that the wavelength locker 102 is insensitive to changes in optical power (i.e., power fluctuations in the input light are not measured as frequency changes). The power reference provided by the first optical detector 140 may also be used for output power monitoring of the laser 110.

The first optical detector 140 may be a semiconductor photodiode and particularly a back-illuminated semiconductor photodiode. A semiconductor photodiode may generally include one or more layers of materials formed on a substrate. The one or more layers may include an optical absorption layer where at least a portion of incident light may be absorbed and electrical energy may be released, i.e., where an incident photon may excite an electron-hole pair that may eventually reach electrodes. In a front-illuminated photodiode, incident light may propagate through the one or more layers before reaching the substrate where it may be lost. In a back-illuminated configuration, the semiconductor photodiode may receive incident light at its substrate. The substrate may include an antireflective coating configured to facilitate propagation of incident light into the substrate. The incident light may thereby propagate through the substrate before reaching the one or more layers. Light that is not absorbed by the optical absorption layer may exit the photodiode opposite the substrate. In this way, at least a portion of the incident light may pass through the back-illuminated photodiode, i.e., the photodiode may be at least partially transparent to the incident light.

In an embodiment, the first optical detector 140 may be a semiconductor photodiode including a combination of Group Ill-V materials. As will be appreciated by one skilled in the art, an appropriate combination of materials may be selected to achieve at least partial optical transparency at a desired wavelength or wavelengths. For example, the first optical detector may include InGaAs, which is at least partially optically transparent to light in the wavelength range of about 950 nm to about 1650 nm.

The first optical detector 140 may be deposited on the first end 151 of the optical interferometer 150 such that the first optical detector 140 is physically coupled to the optical interferometer 150. An antireflective coating may be used between the first optical detector 140 and the optical interferometer 150. The first optical detector 140 may include the antireflective coating at or near its interface with the optical interferometer 150. Alternatively or additionally, the optical interferometer 150 may include the antireflective coating on the first end 151. The antireflective coating prevents the reflection of light at the interface of the first optical detector 140 and the optical interferometer 150 and thus facilitates the transmission of the light through the first optical detector 140 and into the optical interferometer 150. In other embodiments, the first optical detector 140 may be separated from and not physically coupled to the optical interferometer 150.

The second optical detector 160 may be a front-illuminated semiconductor photodiode such as the type known for use in wavelength lockers. The second optical detector 160 may be positioned at an angle, θ₂, and a distance, D, relative to the optical interferometer 150, which may depend on a wavelength of the wavelength locker.

The system 100 may further include a wavelength locker control circuit 170 coupled between the optical detectors 140, 160 of the wavelength locker 102 and the laser 110. The wavelength locker control circuit 170 receives the output of the first optical detector 140 (i.e., a power reference signal 172) and the output of the second optical detector 160 (i.e., a wavelength deviation signal 174). The control circuit 170 may then adjust an emission wavelength of the laser 110 in response to outputs of the optical detectors 140, 160, for example, in response to the wavelength deviation signal from the second optical detector 160 normalized by the power reference signal from the first optical detector 140. In particular, the control circuit 170 may generate one or more tuning signals 176 for adjusting tuning parameters of the laser 110 to achieve the desired wavelength. In this manner, the emission wavelength of the laser 110 may be stabilized or locked to the desired wavelength. The wavelength locker 102 and the wavelength locker control circuit 170 described herein may use other wavelength locking techniques known to those skilled in the art.

FIG. 2 depicts a schematic representation of another embodiment of a wavelength locker 202 consistent with the present disclosure. Similar to the embodiment described above, the wavelength locker 202 includes a first optical detector 240 that is at least partially transparent, an optical interferometer 250, and a second optical detector 260. In this embodiment, the first optical detector 240 may be separated from the optical interferometer 250 and positioned at an angle a relative to the optical interferometer 250. The angle a may be chosen to reduce interference in the first optical detector 240 from reflected light from the optical interferometer 250.

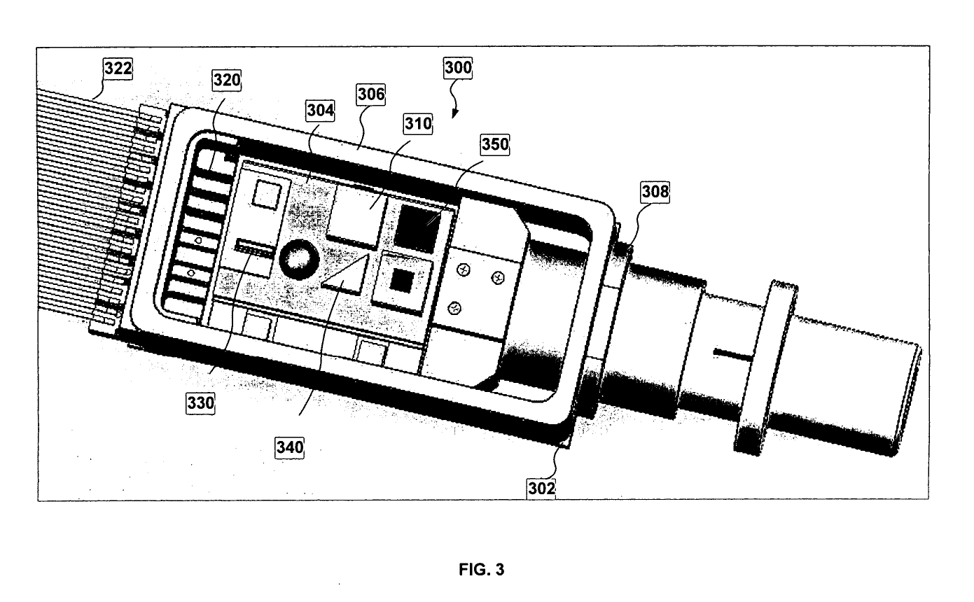

FIG. 3 depicts a physical layout of an embodiment of a tunable TOSA package 300 with a wavelength locker 310. The tunable TOSA package 300 may include a supporting structure formed by a base 302, one or more sub-mounts 304 and a housing 306. A tunable semiconductor laser 330, the wavelength locker 310 and a beam splitter 340 may be mounted within the package 300, for example, on the sub-mount(s) 304. The package 300 may also include other optical and/or electronic components known to those skilled in the art (e.g., mounted to sub-mount(s)), such as one or more lenses, isolators, monitor photodiodes, thermoelectric coolers, thermistors and the like. The TOSA package 300 may also include an optical fiber coupling portion 308 that couples an optical fiber (not shown) to the laser package 300 such that the light output from the laser 330 is coupled into the optical fiber.

The TOSA package 300 may include conductive paths 320 extending from the laser 330, wavelength locker 310 and other electronic components in the package 300 to the exterior of the package 300. The sub-mount(s) 304 may include signal traces (not shown), for example, that form at least part of the conductive paths 320. The laser 330, wavelength locker 310 and other electronic components may be mounted to the sub-mount(s) 304 and electrically connected to the signal traces on the sub-mount(s) 304, for example, using wires bonded between the contacts on the component and the traces on the sub-mount(s) 304. At the exterior of the package 300, leads 322 may be coupled to the conductive paths 320. Thus, the wavelength locker 310 and the laser 330 may be coupled to external circuits via the leads 322, which are electrically coupled to the conductive paths that carry electrical signals from the wavelength locker 310 and/or to the laser 330.

The TOSA package 300 may be coupled to external circuitry, such as a wavelength locker control circuit (not shown). A wavelength locker control circuit may receive outputs from the wavelength locker 310 and, based on those outputs, may adjust an emission wavelength of the laser 330, for example, as described above. In another embodiment, a wavelength locker control circuit may be positioned inside the TOSA package. In an embodiment, the TOSA package 300 may further include a memory device 350 configured to store laser parameters used for tuning and locking the wavelength of the laser 330, for example, as described in U.S. patent application Ser. No. 12/030,499, filed Feb. 13, 2008, and incorporated herein by reference in its entirety.

Accordingly, a wavelength locker, consistent with the embodiments described herein, may be used in a relatively small optical module or package to stabilize or lock an emission wavelength of a laser.

Consistent with one embodiment, a wavelength locker may include a first optical detector configured to detect light. The first optical detector is at least partially transparent to the light. The wavelength locker may further include an optical interferometer that has a first end and a second end. The first end is optically coupled to the first optical detector to receive light passing through the first optical detector and the optical interferometer is configured to selectively filter the received light. The wavelength locker may further include a second optical detector optically coupled to the second end of the optical interferometer. The second optical detector is configured to detect the filtered light.

Consistent with another embodiment, a laser package may include a laser package support structure defining a laser package region and a laser supported by the laser package support structure and within the laser package region. The laser is configured to generate a light output. The laser package may further include a wavelength locker supported by the laser package support structure and optically coupled to the laser. The wavelength locker may include a first optical detector configured to detect the light. The first optical detector is at least partially transparent to the light. The wavelength locker may further include an optical interferometer that has a first end and a second end. The first end is optically coupled to the first optical detector to receive light passing through the first optical detector and the optical interferometer is configured to selectively filter the received light. The wavelength locker may further include a second optical detector optically coupled to the second end of the optical interferometer. The second optical detector is configured to detect the filtered light.

Consistent with a further embodiment, a method of locking a laser may include detecting a light output of a laser using a first optical detector and passing at least a portion of the light output through the first optical detector to an optical interferometer. The method may further include selectively filtering at least a portion of the light output with the optical interferometer and detecting the filtered at least a portion of the light using a second optical detector. The second optical detector is positioned at an angle relative to the optical interferometer. The method may further include comparing the detected light output of the first optical detector and the detected filtered at least a portion of the light of said the optical detector, and adjusting an emission wavelength of the light output of the laser based on the comparison.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A wavelength locker, comprising:
a first optical detector configured to detect light, wherein said first optical detector is at least partially transparent to said light;
an optical interferometer having a first end and a second end, wherein said first end is optically coupled to said first optical detector to receive light passing through said first optical detector, wherein said optical interferometer is configured to selectively filter said received light; and
a second optical detector optically coupled to said second end of said optical interferometer, wherein said second optical detector is configured to detect said filtered light.

2. The wavelength locker of claim 1 wherein said first optical detector comprises InGaAs.

3. The wavelength locker of claim 1 wherein said optical interferometer is an etalon.

4. The wavelength locker of claim 1 wherein said first optical detector is positioned at an angle relative to said optical interferometer.

5. The wavelength locker of claim 1 wherein said second optical detector is positioned at an angle relative to said optical interferometer.

6. The wavelength locker of claim 1 wherein said first optical detector is deposited on said first end of said optical interferometer.

7. The wavelength locker of claim 6 further comprising an antireflective coating between said first optical detector and said optical interferometer.

8. The wavelength locker of claim 1 wherein said first optical detector is a back-illuminated photodiode.

9. The wavelength locker of claim 6 wherein said second optical detector is a front-illuminated photodiode.

10. A laser package comprising:
a laser package support structure defining a laser package region;
a laser supported by said laser package support structure and within the laser package region, the laser being configured to generate a light output; and
a wavelength locker supported by said laser package support structure and optically coupled to said laser, wherein said wavelength locker comprises:
a first optical detector configured to detect said light, wherein said first optical detector is at least partially transparent to said light;
an optical interferometer having a first end and a second end, wherein said first end is optically coupled to said first optical detector to receive said light passing through said first optical detector, wherein said optical interferometer is configured to selectively filter said received light; and
a second optical detector optically coupled to said second end of said optical interferometer, wherein said second optical detector is configured to detect said filtered light.

11. The laser package of claim 10 further comprising a beam splitter supported by said laser package support structure and optically coupled to said laser and said wavelength locker.

12. The laser package of claim 10 further comprising a control circuit configured to receive an output of said first optical detector and an output of said second optical detector, and to generate a control output based on said outputs of said first optical detector and said second optical detector.

13. The laser package of claim 10 wherein said laser package support structure includes a laser package housing, and wherein said laser and said wavelength locker are enclosed in said laser package housing.

14. The laser package of claim 10 wherein said laser package support structure includes an optical fiber coupling portion configured to couple an optical fiber to said laser package such that said light output of said laser is coupled into said optical fiber.

15. The laser package of claim 10 wherein the laser support structure includes at least one laser package submount, and wherein said laser and said wavelength locker are mounted on said at least one laser package submount.

16. The laser package of claim 10 wherein said first optical detector comprises InGaAs.

17. The laser package of claim 10 wherein said optical interferometer is an etalon.

18. The laser package of claim 10 wherein said first optical detector is deposited on said first end of said optical interferometer.

19. The laser package of claim 18 further comprising an antireflective coating between said first optical detector and said optical interferometer.

20. A method of locking a wavelength of a laser comprising:
detecting a light output of a laser using a first optical detector;
passing at least a portion of said light output through said first optical detector to an optical interferometer;
selectively filtering said at least a portion of said light output with said optical interferometer;
detecting said filtered at least a portion of said light using a second optical detector;
comparing said detected light output of said first optical detector and said detected filtered at least a portion of said light of said second optical detector; and
adjusting an emission wavelength of said light output of said laser based on said comparison.
